(19) United States
(12) Patent Application Publication
(10) Pub. No.: US 2020/0262667 A1
(43) Pub. Date: Aug. 20, 2020

(54) SHEET FEEDING DEVICE AND CONTROL METHOD THEREOF

(71) Applicant: KYOCERA Document Solutions Inc., Osaka (JP)

(72) Inventor: Tetsuya UENO, Osaka (JP)

(73) Assignee: KYOCERA Document Solutions Inc., Osaka (JP)

(21) Appl. No.: 16/748,257

(22) Filed: Jan. 21, 2020

(30) Foreign Application Priority Data
Feb. 14, 2019 (JP) 2019-024503

(51) Int. Cl. B65H 7/20; G01N 27/04; B65H 1/26

(52) U.S. Cl. CPC B65H 7/20; B65H 2515/805; B65H 1/266; G01N 27/048

(57) ABSTRACT

A heater of a sheet feeding device warms up a bundle of sheets set in a sheet cassette to dehumidify it. A first terminal makes contact with the topmost sheet. A second terminal makes contact with the bottommost sheet. When judging the necessity for dehumidification, a controller determines a judging resistance value based on the magnitude of a current passing through the bundle of sheets with a detection voltage applied to the first terminal. When the judging resistance value is equal to or lower than a threshold value, the controller operates the heater. When the determined judging resistance value is higher than a threshold value, the controller does not operate the heater.

### INCORPORATION BY REFERENCE

This application is based upon and claims the benefit of priority from the corresponding Japanese Patent Application No. 2019-024503 filed on Feb. 14, 2019, the entire contents of which are incorporated herein by reference.

### BACKGROUND

The present disclosure relates to a sheet feeding device which stores sheets and which feeds them out during printing.

There are image forming apparatuses such as multifunction peripherals and printers. The image forming apparatus stores sheets and feeds them out during printing. In some cases, the stored sheets may absorb moisture to increase the amount of water contained in sheets. When the amount of water absorbed in sheets is large, sheet conveyance failure is more likely to occur. As a solution, some image forming apparatuses incorporate a heater for drying sheets. Some known sheet feeding devices, such as the one described below, incorporate a heater for drying sheets.

Specifically, there is included a sheet feeding device that stores sheets in a stacked manner, heats up the stacked sheets, feeds out the sheets with a conveying member, drives the conveying member, measures the load required to drive the conveying member, and heats up the stacked sheets when the measured value is larger than a first predetermined value. Such a sheet feeding device only heats up the sheets to dehumidify them only when the moisture absorption rate of sheets is high.

When sheets containing a large amount of water are fed, double feeding is likely to occur. Double feeding is an error in which a plurality of sheets are fed and conveyed in an overlapped state. This is caused because sheets are affected by attraction (adsorption) property among water molecules. With sheets containing a large amount of water, also jams are likely to occur. It is preferable to dry the sheets which have absorbed a large amount of water.

On the other hand, driving the heater for drying sheets when the amount of water contained in sheets is small is a waste of energy. The heater should be operated only when the amount of water contained in sheets is large. However, feeding and conveying sheets for checking whether the amount of water is large or not can cause double feeding and jams if the sheets contain a large amount of water. In this case, extra work is needed to recover from an error. Thus, it is a challenge to judge whether the amount of water contained in sheets is large without feeding the sheets.

In the known sheet feeding devices described above, it is necessary to feed sheets in order to measure the load required to drive the conveying member. It is not possible to judge whether the amount of water contained in sheets is large without feeding sheets. Sheets fed for measurement may cause double feeding and jams.

### SUMMARY

According to one aspect of the present disclosure, a sheet feeding device includes a sheet cassette, a heater, a first terminal, a second terminal, and a controller. In the sheet cassette, sheets are set. The heater warms up a bundle of sheets set in the sheet cassette to dehumidify it. The first terminal makes contact with the topmost sheet in the bundle of sheets. The second terminal makes contact with the bottommost sheet in the bundle of sheets. The controller determines a judging resistance value based on the magnitude of a current passing through the bundle of sheets in the sheet cassette with a detection voltage applied to the first terminal when judging the necessity for dehumidification. The controller operates the heater when the determined judging resistance value is equal to or lower than a prescribed threshold value. The controller does not operate the heater when the determined judging resistance value is higher than the prescribed threshold value.

According to another aspect of the present disclosure, a method of controlling a sheet feeding device includes setting sheets in a sheet cassette, bringing a first terminal into contact with the topmost sheet in the bundle of sheets, bringing a second terminal into contact with the bottommost sheet in the bundle of sheets, determining a judging resistance value based on the magnitude of a current passing through the bundle of sheets in the sheet cassette with a detection voltage applied to the first terminal when judging the necessity for dehumidification, operating a heater which warms up the bundle of sheets set in the sheet cassette to dehumidify them when the determined judging resistance value is equal to or lower than a prescribed threshold value, and not operating the heater when the determined judging resistance value is higher than the prescribed threshold value.

This and other characteristics of the present disclosure, and the specific benefits obtained according to the present disclosure, will become apparent from the description of embodiments which follows.

### BRIEF DESCRIPTION OF THE DRAWINGS

FIG. 1 is a diagram showing one example of a printer according to an embodiment.

FIG. 2 is a diagram showing one example of a sheet feeder according to the embodiment.

FIG. 3 is a diagram showing the one example of the sheet feeder according to the embodiment.

FIG. 4 is a diagram showing the one example of the sheet feeder according to the embodiment.

FIG. 5 is a diagram showing one example of a remaining quantity sensor according to the embodiment.

FIG. 6 is a diagram showing the one example of the remaining quantity sensor according to the embodiment.

FIG. 7 is a diagram showing one example of supply of electric power on the printer according to the embodiment.

FIG. 8 is a diagram showing one example of measurement of a resistance value of a bundle of sheets on the printer according to the embodiment.

FIG. 9 is a diagram showing the one example of the measurement of the resistance value of a bundle of sheets on the printer according to the embodiment.

FIG. 10 is a diagram showing one example of judgment of necessity for dehumidification on the printer according to the embodiment.

FIG. 11 is a diagram showing one example of threshold value definition data according to the embodiment.

### DETAILED DESCRIPTION

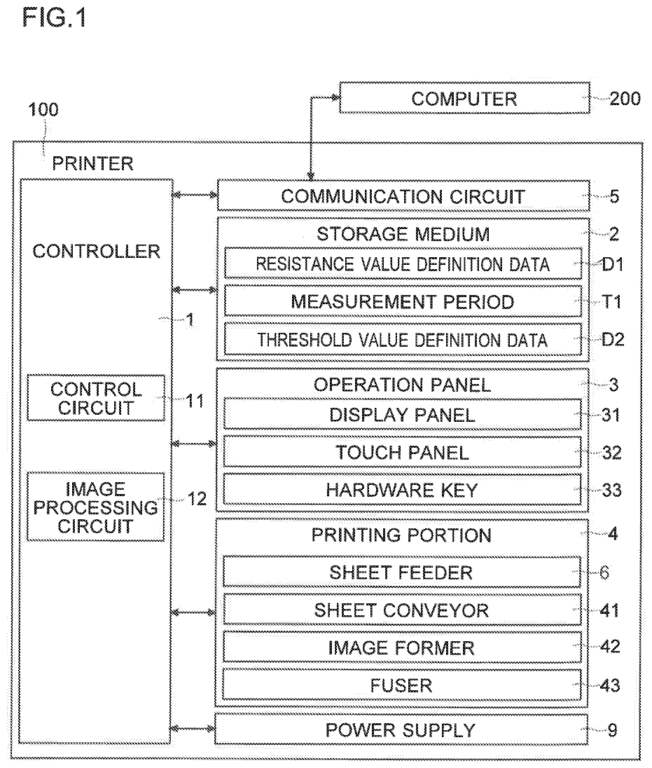

A sheet feeding device according to the present disclosure accurately judges, without feeding or conveying a sheet, whether dehumidification with a heater is necessary, and only when needed, operates the heater to prevent double feeding and clogging. Hereinafter, with reference to FIGS. 1 to 11, an embodiment of the present disclosure will be described. A printer 100 for printing will be taken as an example of the sheet feeding device (image forming apparatus) in the description below. The sheet feeding device is not limited to a printer. The sheet feeding device may be an image forming apparatus of any other type, such as a multifunction peripheral. All the features described in connection with the embodiment in terms of structures, arrangements, and the like are merely examples and are not meant to limit the scope of the disclosure.

(Printer 100)

With reference to FIG. 1, one example of the printer 100 according to an embodiment will be described. The printer 100 includes a controller 1, a storage medium 2, an operation panel 3, a printing portion 4, and a communication circuit 5.

The controller 1 controls operation of the printer 100. The controller 1 includes a control circuit 11 and an image processing circuit 12. The control circuit 11 is, for example, a CPU. The image processing circuit 12 is an integrated circuit for image processing (for example, an ASIC). The control circuit 11 controls, based on programs and data stored in the storage medium 2, different parts (the operation panel 3, the printing portion 4, and the communication circuit 5). The image processing circuit 12 performs various kinds of image processing.

The storage medium 2 includes a ROM, a storage, and a RAM. The ROM is, for example, a flash ROM. The storage is a large non-volatile storage device such as an HDD or an SSD, The storage medium 2 stores various kinds of data and control programs. For example, the storage medium 2 stores control data, setting data, and image data.

The operation panel 3 includes a display panel 31, a touch panel 32, and hardware keys 33. The display panel 31 displays a screen and an image. The controller 1 (control circuit 11) controls display on the display panel 31. The controller 1 makes the display panel 31 display operation images used for setting of a job. The operation images include, for example, buttons, keys, and tabs. The touch panel 32 accepts user operation. The touch panel 32 is provided on the top face of the display panel 31. The touch panel 32 recognizes the touched position. Based on the output from the touch panel 32, the controller 1 recognizes the operated operation image. Based on the operated operation image, the controller 1 recognizes user operation. Hardware keys 33 also accept user operation. The operation panel 3 accepts, for example, a setting for printing resolution in a printing job.

The printer 100 includes a printing portion 4. The printing portion 4 includes a sheet feeder 6, a sheet conveyor 41, an image former 42, and a fuser 43. The sheet feeder 6 will be described in detail later. The sheet conveyor 41 includes, for example, a motor and a conveying roller pair. The controller 1 makes the sheet conveyor 41 convey the sheet fed out from the sheet feeder 6. The image former 42 includes, for example, a photosensitive drum, a charging device, an exposure device, a developing device, and a transfer roller. The controller 1 operates such that a photosensitive drum is electrostatically charged and is exposed based on image data. The controller 1 has an electrostatic latent image on the photosensitive drum developed with toner. The controller 1 operates such that a toner image is transferred to a sheet. The fuser 43 includes, for example, a fixing heater 8 and a fixing roller. The controller 1 makes the fuser 43 heat and press the sheet to which the toner image has been transferred. The controller 1 makes the fuser 43 fix the toner image.

The controller 1 includes a communication circuit 5. The communication circuit 5 includes, for example, a communication control circuit and a communication memory. The communication memory stores communication software. The communication circuit 5 (a circuit for communication) can communicate with a computer 200 via a network. The computer 200 is, for example, a PC or a server. The communication circuit 5 receives printing data from the computer 200.

Printing data includes, for example, data written in a page description language. The controller 1 (the image processing circuit 12) analyzes data written in a page description language to generate image data (rasterization processing). The controller 1 (the image processing circuit 12) performs image processing on generated image data to generate output image data, Based on output image data, the controller 1 makes the printing portion 4 perform printing.

(Sheet Feeder 6)

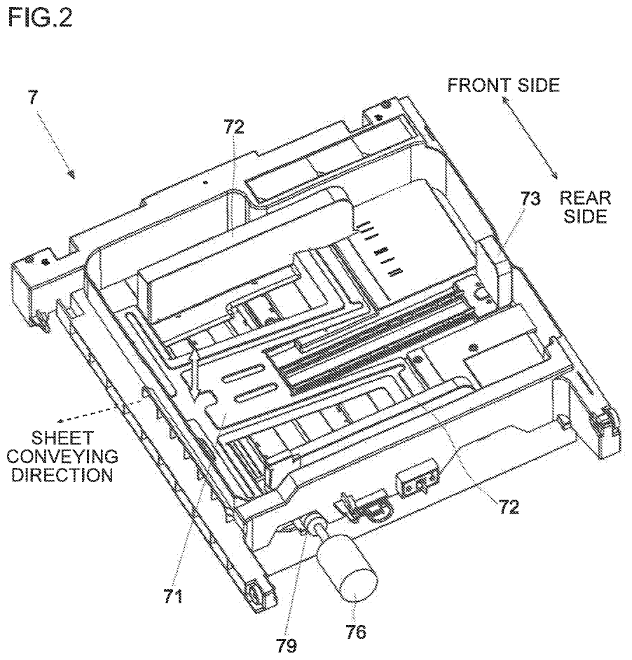

Next, with reference to FIGS. 2 to 6, the sheet feeder 6 according to the embodiment will be described. The sheet feeder 6 is a portion for storing sheets to feed them out one after another. A plurality of sheet feeders 6 can be stacked over each other. The sheet feeder 6 includes a sheet cassette 7. The sheet cassette 7 stores sheets. The sheet cassette 7 can be removed from the printer 100, The sheet cassette 7 can be pulled out to replenish it with sheets. The sheet cassette 7 can be pulled out to change the sheets that are set. To return the sheet cassette 7 that is pulled out, a user pushes in the sheet cassette 7.

The sheet cassette 7 includes a lift plate 71, two width regulation cursors 72, and a rear end regulation cursor 73. Sheets (a bundle of sheets) are set on the lift plate 71. An upstream-side end part (a right-side end part in FIG. 2) of the lift plate 71 is pivotably supported by a supporting portion 74.

A downstream-side end part (a left-side end part in FIG. 2) of the lift plate 71 is a free end. The lift plate 71 is pivotable in the up-down direction. A lift mechanism 75 makes the lift plate 71 ascend and descend. The lift mechanism 75 is provided under the lift plate 71. The lift mechanism 75 includes a lift motor 76, a driving shaft 77, and a push-up plate 78.

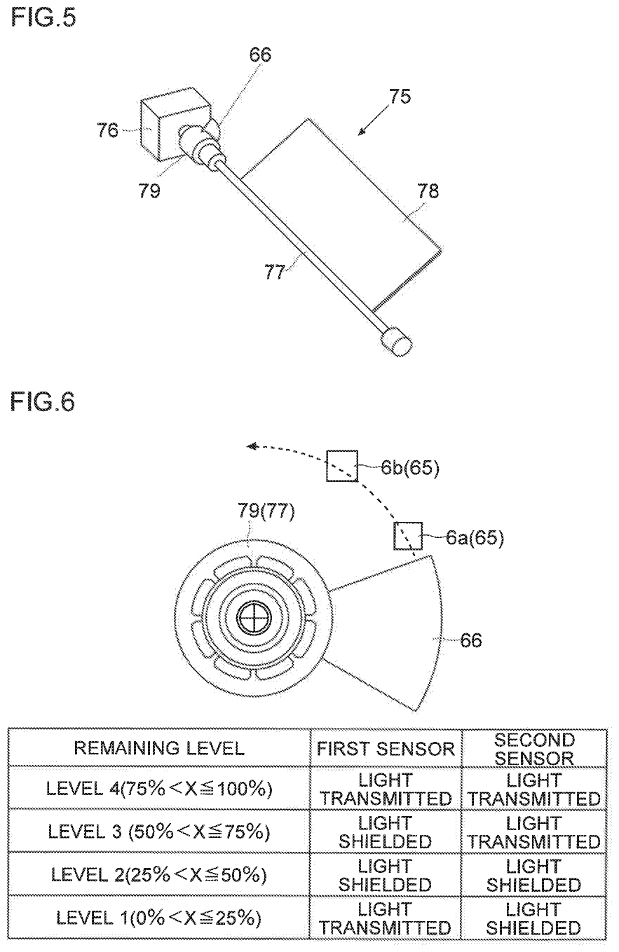

The lift motor 76 is provided outside the sheet cassette 7 (on the main body side). The longitudinal direction of the driving shaft 77 is a direction perpendicular to the sheet conveying direction. The driving shaft 77 is coupled to the lift motor 76 via a joint member 79 (see FIG. 5). The push-up plate 78 is fitted to the driving shaft 77. The driving shaft 77 rotates by being driven by the lift motor 76. The controller 1 operates the lift motor 76 to rotate the driving shaft 77. This makes the push-up plate 78 pivot. When the push-up plate 78 pivots, the lift plate 71 (downstream-side end part) ascends (is lifted up). During printing, the controller 1 makes the lift plate 71 ascend until sheets make contact with the sheet feeding roller 61.

When the sheet cassette 7 is pulled out, the joint member 79 and the driving shaft 77 decouple from each other. When the sheet cassette 7 is removed (decoupled), the lift plate 71 descends automatically by the action of gravity (under its own weight). The lift mechanism 75 makes the lift plate 71 descend under gravity. Eventually, the lift plate 71 and the push-up plate 78 descend down to their lower limit positions. The lift plate 71 and the push-up plate 78 lie flat. The in plate 71 is configured not to lower under its own weight when the joint member 79 and the driving shaft 77 are coupled together.

When the sheet cassette 7 is fitted, the driving shaft 77 is inserted in the joint member 79. The joint member 79 and the driving shaft 77 are coupled together. Based on the output of an open/close sensor (details will be given later), the controller 1 recognizes that the sheet cassette 7 is attached. By the time that sheet feeding is started, the controller 1 drives the lift motor 76. The controller 1 makes the lift plate 71 (sheet feeding roller 61) ascend up to its upper limit position. The controller 1 makes the lift motor 76 rotate momentarily every time one sheet is or a plurality of sheets are fed. The controller 1 lifts the sheet feeding roller 61, which has descended a little due to sheet consumption, up to the upper limit position again.

The sheet feeder 6 includes a sheet feeding mechanism. The sheet feeding mechanism includes a sheet feeding roller 61, a separating roller pair 62 (a feed roller and a retard roller), and a sheet feeding motor 60. The sheet feeding roller 61 is provided over the downstream-side end part of the lift plate 71. Separating roller pair 62 is provided on the downstream side of the sheet feeding roller 61 in the conveying direction. The separating roller pair 62 prevents double feeding of sheets. The upper feed roller of the separating roller pair 62 rotates in such a direction (forward direction) as to feed a sheet to a sheet conveyor 41 (conveying passage). The lower retard roller rotates in such a direction (reverse direction) as to feed a sheet to the sheet cassette 7. The retard roller is configured to rotate in the forward direction when a predetermined force is applied to it. When only one sheet is fed (when double feeding is not occurring), the retard roller rotates forward. For example, a torque limiter is used. On the other hand, when double feeding of sheets is occurring, the retard roller feeds the lower sheet backward.

The sheet feeding motor 60 makes the sheet feeding roller 61 and the separating roller pair 62 rotate. During a printing job, the controller 1 makes the sheet feeding motor 60 rotate to feed a sheet to the sheet feeder 6. The sheet fed out from the sheet feeder 6 is fed in the sheet conveyor 41. The controller 1 makes the sheet conveyor 41 convey the sheet fed out from the sheet feeder 6.

The rotary shaft of the sheet feeding roller 61 is supported on a supporting shaft member 63. The supporting shaft member 63 is laid on the rotary shaft of the separating roller pair 62 (feed roller). An upstream-side end part of the supporting shaft member 63 in the sheet conveying direction can swing in the up-down direction. With the supporting shaft member 63, the sheet feeding roller 61 can swing in the up-down direction.

When the lift motor 76 is rotated to raise the lift plate 71, the sheet feeding roller 61 and the topmost sheet makes contact with each other. The topmost sheet is the sheet at the top of the sheets on the lift plate 71. When the lift plate 71 is raised further, also the sheet feeding roller 61 is lifted up. That is, the lift plate 71 lifts a bundle of sheets and the sheet feeding roller 61.

The sheet feeder 6 includes an upper limit sensor 64. The upper limit sensor 64 senses that the sheet feeding roller 61 has reached its upper limit. The upper limit of the sheet feeding roller 61 is also the upper limit of the lift plate 71. The position (height) of the sheet feeding roller 61 at the upper limit is constant. On the other hand, the position (height) of the lift plate 71 at the upper limit varies depending on the thickness of the bundle of sheets that is set. The controller 1 raises the lift plate 71 according to the remaining quantity of sheets such that the sheet feeding roller 61 and the sheets make contact with each other. When the upper limit sensor 64 senses that the sheet feeding roller 61 (lift plate 71) has reached its upper limit, the controller 1 stops the lift motor 76.

As shown in FIG. 4, the sheet feeder 6 includes a remaining sheet quantity sensor 65. The remaining sheet quantity sensor 65 senses the remaining level of sheets (the level of the thickness of a bundle of sheets) that are set in the sheet cassette 7 (on the lift plate 71). Depending on how high the lift plate 71 has risen when it reaches its upper limit, the remaining sheet quantity sensor 65 changes the output level.

As shown in FIG. 5, a fan-shaped plate (remaining quantity sensing plate 66) is fitted to the joint member 79 or the driving shaft 77. The rotation angle of the remaining quantity sensing plate 66 changes according to the rotation angle of the joint member 79 (driving shaft 77). On a path along which an arc part of the remaining quantity sensing plate 66 moves, there are provided first and second sensors 6a and 6b The first and second sensors 6a and 6b are optical sensors of a transmissive type. The remaining quantity sensing plate 66 (the arc part, an end part) passes between the light emitting portion and the light receiving portion of the first and second sensors 6a and 6b. The first and second sensors 6a and 6b output different levels depending on whether they are in a light-transmitted state or in a light-shielded state. The outputs of the first and second sensors 6a and 6b are input to the controller 1, Based on the combination of the output values input to it, the controller 1 recognizes the remaining level of sheets.

Depending on the rotation amount of the driving shaft 77, the number of sensors that the remaining quantity sensing plate 66 shields from light changes. FIG. 6 shows one example of the remaining quantity sensing plate 66 when the remaining quantity is 100%. To bring the sheet feeding roller 61 and sheets into contact with each other, the controller 1 rotates the driving shaft 77. The thinner the bundle of sheets set on the placing plate 53 (the smaller the remaining quantity), the larger the amount by which the remaining quantity sensing plate 66 (driving shaft 77) needs to rotate until the sheet feeding roller 61 reaches its upper limit.

The first and second sensors 6a and 6b are provided at positions at which they are not shielded from light by the remaining quantity sensing plate 66 when the rate X of the thickness of the bundle of sheets that is set relative to the thickness of the bundle of sheets at full capacity is 75%<X≤100%. The first sensor 6a is provided at a position at which it is shielded from light by the remaining quantity sensing plate 66 when the rate X of the thickness of the bundle of sheets that is set relative to the thickness of the bundle of sheets at full capacity is 50%<X≤75% The second sensor 6b is provided at a position at which it is not shielded from light by the remaining quantity sensing plate 66. The first and second sensors 6a and 6b are provided at positions at which they are shielded from light by the remaining quantity sensing plate 66 when the rate X of the thickness of the bundle of sheets that is set relative to the thickness of the bundle of sheets at full capacity is 25%<X≤50%. The first sensor 6a is provided at a position at which it is not shielded from light by the remaining quantity sensing plate 66 when the rate X of the thickness of the bundle of sheets that is set relative to the thickness of the bundle of sheets at full capacity is 0%≤X≤25%. The second sensor 6b is provided at a position at which it is not shielded from light by the remaining quantity sensing plate 66 (see FIG. 6).

Based on the output levels of the first and second sensors 6a and 6b, the controller 1 recognizes the remaining level (range of the remaining quantity) of sheets. When the output levels of the first and second sensors 6a and 6b are those in the light-transmitted state, the controller 1 recognizes that the remaining level is 4 (the remaining quantity 75%<X≤100%). When the output level of the first sensor 6a is that in the light-shielding state and the output level of the second sensor 6b is that in the light-transmitted state, the controller 1 recognizes that the remaining level is 3 (the remaining quantity 50%<X≤75%). When the output levels of the first and second sensors 6a and 6b are those in the light-shielded state, the controller 1 recognizes that the remaining level is 2 (the remaining quantity 25%<X 50%). When the output level of the first sensor 6a is that in a light-transmitted state and the output level of the second sensor 6b is that in a light-shielded state, the controller 1 recognizes that the remaining level is 1 (the remaining quantity 0%≤X≤25%). In this way, the controller 1 recognizes the remaining level of sheets in the sheet cassette 7 based on the output of the remaining sheet quantity sensor 65.

As shown in FIG. 4, the sheet feeder 6 includes an open/closed detection sensor 67. The open/closed detection sensor 67 is a sensor for sensing whether the sheet cassette 7 is in or out. Based on the output of the open/closed detection sensor 67, the controller 1 recognizes whether the sheet cassette 7 is pulled out or closed.

The sheet feeder 6 includes an empty sensor 68. The empty sensor 68 is a sensor which detects whether there are sheets that are set in the sheet cassette 7, Based on the output of the empty sensor 68, the controller 1 recognizes the presence or absence of sheets in the sheet cassette 7 and whether sheets have run out.

The sheet feeder 6 includes the heater 8. The heater 8 is for dehumidifying and drying sheets. The heater 8 is provided on the top face of sheets (over the lift plate 71). The heater 8 may be provided under the sheets. The heater 8 is a planar (plate-form, sheet-form) heat source including a heating wire. The heater 8 generates heat when energized. When dehumidifying a sheet, the controller 1 supplies the heater 8 with electric power and operates it.

(Active Mode and Power Saving Mode)

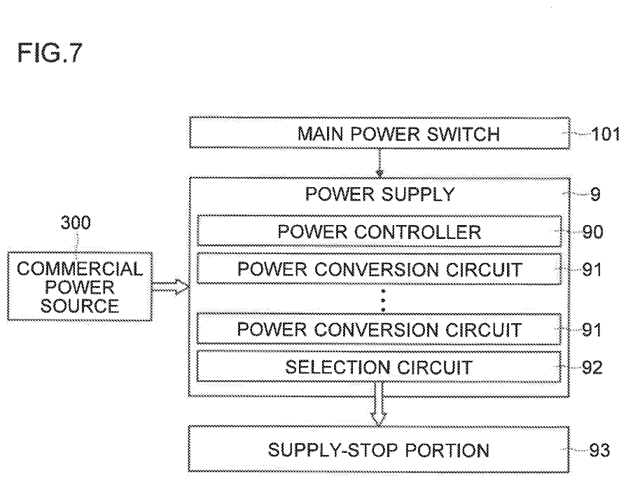

Next, with reference to FIG. 7, one example of modes of the printer 100 according to the embodiment will be described. The printer 100 includes a power supply 9. The power supply 9 receives supply of electric power from a commercial power source 300 (electric outlet). For example, a distribution outlet and the power supply 9 are connected together with a power cord. The power supply 9 includes a power controller 90, a power conversion circuit 91, and a selection circuit 92. The power controller 90 controls the operation of the power conversion circuit 91 and the selection circuit 92. The power conversion circuit 91 performs rectification and voltage conversion (voltage bucking). The power conversion circuit 91 generates a voltage required for operating the printer 100.

The printer 100 has an active mode and a power saving mode, Active mode is a mode in which the power supply 9 supplies electric power to all parts of the printer 100. Active mode is a mode in which the printer 100 is kept in a printable state. When the power of the printer 100 is turned on with a main power switch, the supply of electric power to the controller 1, the storage medium 2, the operation panel 3, the printing portion 4, and the communication circuit 5 is started. Different parts start up, and the printer 100 starts up in active mode.

In power saving mode, the power supply 9 stops supplying electric power to a prescribed portion (supply-stop portion 93) in the printer 100. The supply-stop portion 93 includes, for example, the controller 1, the storage medium 2, the display panel 31, and the printing portion 4. To achieve power saving mode, the power supply 9 includes the selection circuit 92 for switching whether or not to feed electric power to the supply-stop portions 93. The power controller 90 controls the selection circuit 92. The power controller 90 is, for example, a microprocessor. The selection circuit 92 is, for example, a semiconductor switch.

A condition for shifting from active mode to power saving mode is prescribed. When, for example, after start-up by turning on the main power, or after completion of a printing job, a prescribed shift time has passed without a printing job being performed, the controller 1 makes the power supply 9 stop the supply of electric power to the supply-stop portion (shift to power saving mode). The power supply 9 (power controller 90) makes the selection circuit 92 stop the supply of electric power to the supply-stop portions 93.

Also a condition for recovery from power saving mode to active mode is prescribed. Upon receiving an interruption signal from a part to which electric power is supplied even during power saving mode, the power supply 9 restarts the supply of electric power to the supply-stop portion 93. When, for example, the operation panel 3 (touch panel 32) senses a touch, the operation panel 3 feeds an interruption signal to the power supply 9. Also, upon receiving printing data, the communication circuit 5 feeds an interruption signal to the communication circuit 5. The power supply 9 (power controller 90) makes the selection circuit 92 restart the supply of electric power to the supply-stop portions 93. The supply-stop portion 93 is restarted. When the entire supply-stop portion 93 is restarted, active mode starts.

(Measurement of a Resistance Value)

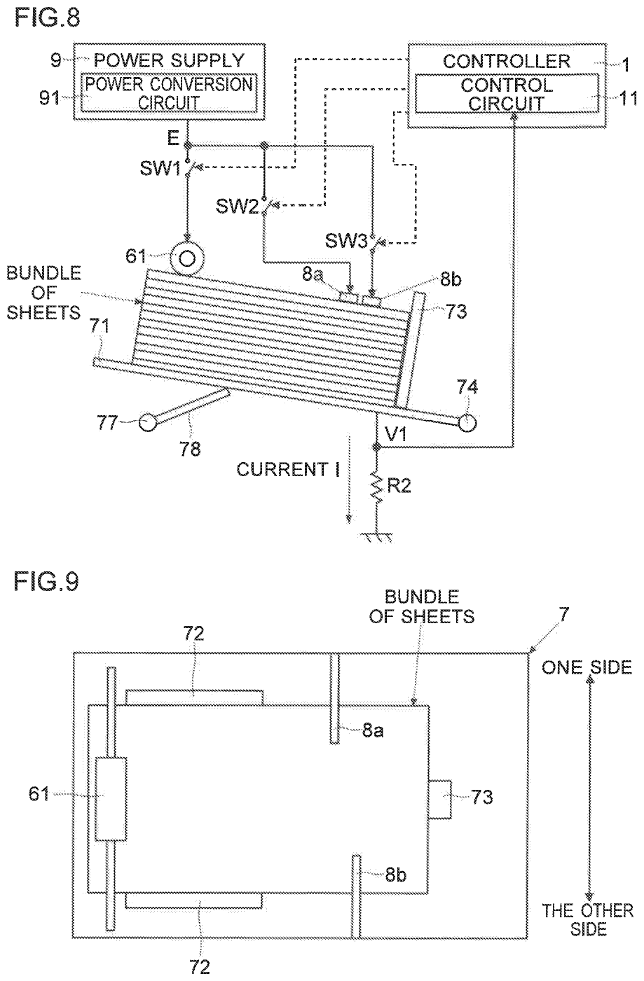

Next, with reference to FIGS. 8 to 9, one example of measurement of the resistance value of a bundle of sheets on the printer 100 according to the embodiment will be described. To find the electrical resistance value of a bundle of sheet, the sheet feeder 6 includes first and second terminals. With a detection voltage E applied to the first terminal, a current I flows through the bundle of sheets that is set in the sheet cassette 7. Based on the magnitude of the current I, the controller 1 recognizes the resistance value of the bundle of sheets.

The first terminal makes contact with the topmost sheet of the sheets that are set in the sheet cassette 7. The second terminal makes contact with the bottommost sheet of the sheets that are set in the sheet cassette 7. The bottommost sheet is the sheet at the bottom of the bundle of sheets.

As shown in FIG. 8, the sheet feeding roller 61 can be used as the first terminal. When the sheet feeding roller 61 is used as the first terminal, the circumferential face of the sheet feeding roller 61 (the part making contact with the topmost sheet) is formed of, for example, electrically conductive rubber.

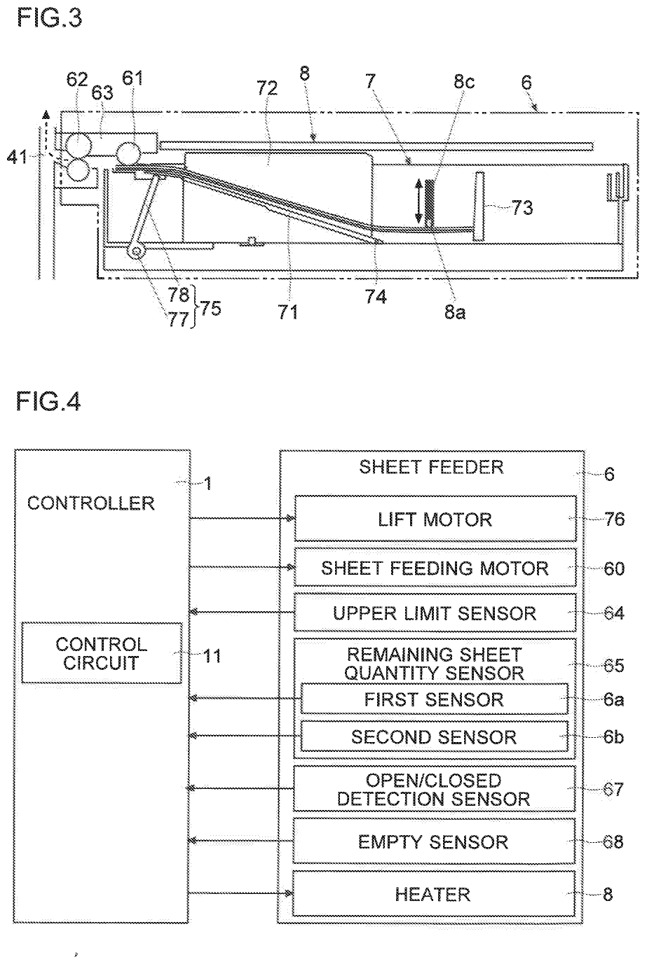

As the first terminal, a metal claw may be provided in the sheet feeder 6 (sheet cassette 7). The metal claw also has a function of pressing the topmost sheet. The metal claw can move in the up-down direction. For example, a guide groove 8c for guiding the movement of the metal claw in the up-down direction is provided in a wall surface (see FIG. 3). The metal claw protrudes from the wall surface (guide groove 8c) of the sheet cassette 7. The metal claw protrudes in the direction perpendicular to the sheet conveying direction. The metal claw is biased downward. The metal claw is biased with, for example, an elastic body such as a spring. This allows the metal claw to make contact with the topmost sheet regardless of the remaining quantity of sheets. As shown in FIG. 9, the sheet feeder 6 in this embodiment may include two metal claws. The metal claw at one side of the sheet cassette 7 in the direction perpendicular to the sheet-conveying direction is a first metal claw 8a, and the metal claw at the other side is a second metal claw 8b.

As shown in FIG. 8, the lift plate 71 may be used as the second terminal. When the lift plate 71 is used as the second terminal, an electrically conductive metal plate (for example, an iron plate) may be used as the lift plate 71.

The power supply 9 (power conversion circuit 91) generate also the detection voltage E to be applied to the first terminal. The power supply 9 applies the detection voltage E to the first terminal. On the other hand, the second terminal is connected to one end of a detection resistor R2. The other end of the detection resistor R2 is connected to ground. The voltage between the detection resistor R2 and the lift plate 71 (the voltage between the terminals for the detection resistance R2) is fed as a resistance value judging voltage value V1 to the controller 1 (control circuit 11). The controller 1 (control circuit 11) performs A/D conversion to recognize the magnitude of the resistance value judging voltage value V1.

When the detection voltage E is applied to the first terminal, a current I flows through the bundle of sheets. The smaller the resistance value of the bundle of sheets, the larger the current I. and thus the larger the resistance value judging voltage value V1. The larger the resistance value of the bundle of sheets, the smaller the current I, and thus the smaller the resistance value judging voltage value V1. Based on the magnitude of the resistance value judging voltage value V1, the controller 1 finds (recognizes) the resistance value of the bundle of sheets.

The controller 1 may calculate the resistance value, for example, based on the magnitude of a divided voltage. The resistance value judging voltage value V1 can be expressed by the following formula.

V1=E×R2/(R1+R2)

Here, the resistance value judging voltage value V1 is found through measurement. The detection voltage E and the resistance value of the detection resistance R2 are known values. Solving the above formula with respect to R1 gives R1=((R2×E) V1)−R2. With values substituted in V1, E, and R2, the resistance value of the bundle of sheets can be found.

The storage medium 2 may store resistance value definition data D1 in a non-volatile manner (see FIG. 1). Resistance value definition data D1 is data (a table) in which the resistance value of the bundle of sheets corresponding to the resistance value judging voltage value V1 is defined. The controller 1 refers to the resistance value definition data D1 to find the resistance value of the bundle of sheets.

(Judgment of Necessity for Dehumidification)

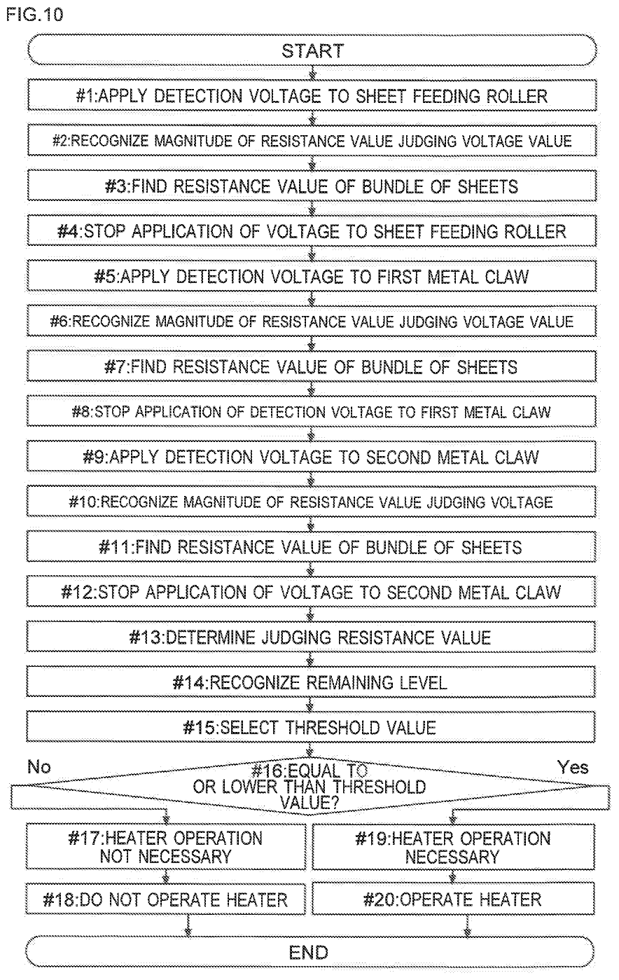

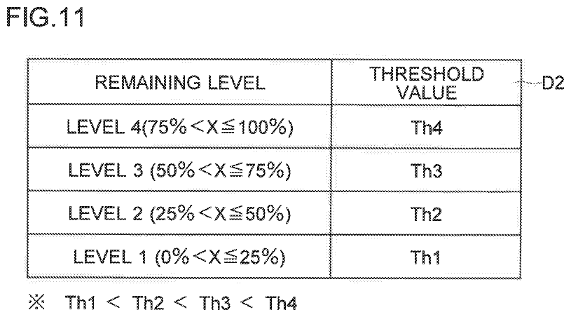

Next, with reference to FIGS. 10 and 11, one example of judgment of the necessity for dehumidification on the printer 100 according to the embodiment will be described. “START” in FIG. 10 is a time point at which judgement of the necessity for dehumidification is started. When judgement of the necessity for dehumidification is started, the controller 1 makes the lift plate 71 rise up to its upper limit. When, for example, the main power to the printer 100 is turned on, the controller 1 judges the necessity for dehumidification. After the initial judgement, the controller 1 may judge the necessity for dehumidification periodically. In other words, the controller 1 may monitor the necessity for dehumidification every prescribed measurement period T1. The measurement period T1 can be any time period, for example, from several minutes to several hours.

When judgment is performed periodically, the controller 1 may judge the necessity for dehumidification regardless of the mode of the printer 100. As described above, the printer 100 has active mode and power saving mode. When the time point for judgement comes during power saving mode, the power supply 9 (power controller 90) may temporarily restart the supply of electric power to the controller 1, the storage medium 2, and the printing portion 4 (the sheet feeder 6 and the remaining sheet quantity sensor 65). When the judgement is completed, the power supply 9 stops the supply of electric power to the controller 1, the storage medium 2, and the printing portion 4 (the sheet feeder 6, the remaining sheet quantity sensor 65). The controller 1 may temporarily cancel the power saving mode to judge the necessity for dehumidification.

The controller 1 applies the detection voltage E to the sheet feeding roller 61 (step #1). A first switch SW1 is provided to control the turning on and off of the detection voltage E for the sheet feeding roller 61 (see FIG. 8). When the detection voltage E is applied to the sheet feeding roller 61, the controller 1 turns on the first switch SW1 (turns off the second and third switches SW2 and SW3). As a result, the detection voltage E from the power supply 9 (power supply circuit) is applied to the sheet feeding roller 61.

Next, the controller 1 recognizes the magnitude of the resistance value judging voltage value V1 during the application of the detection voltage E to the sheet feeding roller 61 (step #2). Based on the magnitude of the recognized resistance value judging voltage value V1, the controller 1 finds the resistance value of a bundle of sheets (step #3). Then, the controller 1 stops the application of the detection voltage E to the sheet feeding roller 61 (step #4). The controller 1 turns off the first switch SW1.

Next, the controller 1 applies the detection voltage E to the first metal claw 8a (step #5). The second switch SW2 is provided to control the turning on and off of the detection voltage E for the first metal claw 8a. When the detection voltage E is applied to the first metal claw 8a, the controller 1 turns on the second switch SW2 (turns off the first and third switches SW1 and SW3). As a result, the detection voltage E from the power supply 9 (power supply circuit) is applied to the first metal claw 8a.

Next, the controller 1 recognizes the magnitude of the resistance value judging voltage value V1 during the application of the detection voltage E to the first metal claw 8a (step #6). Based on the magnitude of the recognized resistance value judging voltage value V1, the controller 1 finds the resistance value of the bundle of sheets (step #7). Then, the controller 1 stops the application of the detection voltage E to the first metal claw 8a (step #8). The controller 1 turns off the second switch SW2.

Furthermore, the controller 1 applies the detection voltage E to the second metal claw 8b (step #9). The third switch SW3 is provided to control the turning on and off of the detection voltage E for the second metal claw 8b. When the detection voltage E is applied to the second metal claw 8b, the controller 1 turns on the third switch SW3 (turns off the first and second switches SW1 and SW2), As a result, the detection voltage E from the power supply 9 (power supply circuit) is applied to the second metal claw 8b.

Next, the controller 1 recognizes the magnitude of the resistance value judging voltage value V1 during the application of the detection voltage E to the second metal claw 8b (step #10). Based on the magnitude of the recognized resistance value judging voltage value V1, the controller 1 finds the resistance value of the bundle of sheets (step #11). Then, the controller 1 stops the application of the detection voltage E to the second metal claw 8b (step #12). The controller 1 turns off the third switch SW3.

Based on the calculated resistance value of the bundle of sheets, the controller 1 determines a judging resistance value (step #13). Specifically, the controller 1 determines, as the judging resistance value, the average value of the resistance value (calculated in step #3) of the bundle of sheets as observed when the detection voltage E is applied to the sheet feeding roller 61, the resistance value (calculated in step #7) of the bundle of sheets as observed when the detection voltage E is applied to the first metal claw 8a, and the resistance value (calculated in step #11) of the bundle of sheets as observed when the detection voltage E is applied to the second metal claw 8b.

The detection voltage E may by applied only to the sheet feeding roller 61. In this case, the controller 1 executes only steps #1 to #4 out of steps #1 to #12. Then, the controller 1 takes, as the judging resistance value, the resistance value of the bundle of sheets obtained as a result of the application of the detection voltage E to the sheet feeding roller 61. The detection voltage E may be applied only to the first metal claw 8a. In this case, the controller 1 executes only steps #5 to #8 out of steps #1 to #12. Then, the controller 1 takes, as the judging resistance value, the resistance value of the bundle of sheets obtained as a result of the application of the detection voltage E to the first metal claw 8a. The detection voltage E may be applied only to the second metal claw 8b. In this case, the controller 1 executes only steps #9 to #12 out of steps #1 to #12. Then, the controller 1 takes, as the judging resistance value, the resistance value of the bundle of sheets obtained as a result of the application of the detection voltage E to the second metal claw 8b.

Next, the controller 1 recognizes the remaining level in the sheet cassette 7 (step #14). The controller 1 selects the threshold value corresponding to the recognized remaining level (step #15). The resistance value of the bundle of sheets is affected by the thickness of the bundle of sheets. Selecting the threshold value corresponding to the remaining level of sheets helps improve the accuracy of the judgment.

For example, the storage medium 2 stores threshold value definition data D2. Threshold value definition data D2 is data (a table) in which the threshold value corresponding to the remaining level is defined. FIG. 11 shows one example of threshold value definition data D2. As shown in FIG. 11, the larger the remaining quantity (the higher the remaining level) is, the larger threshold value is defined; the smaller the remaining quantity (the lower the remaining level) is, the smaller threshold value is defined.

The threshold value corresponding to a given remaining level is determined appropriately. Each threshold value can be determined through an experiment. With respect to data in FIG. 11, how the threshold value is determined will be described. For example, the resistance value of a bundle of sheets of which the thickness is 75% of that at full capacity and of which the water content is the reference water content is taken as a threshold value Th4. The resistance value of a bundle of sheets of which the thickness is 50% of that at full capacity and of which the water content is the reference water content is taken as a threshold value Th3. The resistance value of a bundle of sheets of which the thickness is 25% of that at full capacity and of which the water content is the reference water content is taken as a threshold value Th2. The resistance value of a bundle of sheets of which the thickness is 5% of that at full capacity and of which the water content is the reference water content is taken as a threshold value Th1. The water content is the proportion of water contained in the sheets. For example, the water content in dry sheets is about 3%. The reference water content may be determined based on the water content in sheets with which double feeding or jams start to occur frequently.

Sheets with larger amounts of water tend to have lower resistance values. Thus, the controller 1 checks whether the judging resistance value is equal to or lower than the selected threshold value (step #16). When the judging resistance value is higher than the selected threshold value (No in step #16), the controller 1 judges that the operation of the heater 8 is not necessary (step #17). The controller 1 does not operate the heater 8 (step #18). That is, the controller 1 does not make the power supply 9 energize the heater 8. Then, the controller 1 ends the procedure (END).

When the judging resistance value is equal to or lower than the threshold value (Yes in step #16), the controller 1 judges that operation of the heater 8 is necessary (step #19), and the controller 1 operates the heater 8 (step #20). That is, the controller 1 makes the power supply 9 energize the heater 8. Then, the controller 1 ends the procedure (END).

The time (energizing time) for which to operate the heater 8 may be prescribed. In this case, the power supply 9 (power controller 90) continues to energize the heater 8 for the prescribed operation time and then stops the operation of the heater 8 (stops energization). The power supply 9 (power controller 90) may continue to operate (energize) the heater 8 until the judgement of the necessity for next dehumidification is started.

In this way, the sheet feeding device according to the embodiment includes the sheet cassette 7, the heater 8, the first and second terminals, and the controller 1. Sheets are set in the sheet cassette 7, The heater 8 warms up a bundle of sheets that is set in the sheet cassette 7 to dehumidify it. The first terminal makes contact with the topmost sheet of the bundle of sheets. The second terminal makes contact with the bottommost sheet of the bundle of sheets. When judging the necessity for dehumidification, the controller 1 determines the judging resistance value based on the magnitude of the current I passing through the bundle of sheets in the sheet cassette with the detection voltage E applied to the first terminal. When the determined judging resistance value is equal to or lower than the prescribed threshold value, the controller 1 operates the heater 8. When the determined judging resistance value is higher than the prescribed threshold value, the controller 1 does not operate the heater 8.

It is known that the less the water contained in sheets, the smaller the electrical resistance value of the sheets. By applying a voltage to a stored bundle of sheets, based on the current I passing through the bundle of sheets, the judging resistance value can be determined. Based on the determined judging resistance value, without feeding or conveying sheets, the necessity for dehumidification can be judged. In other words, without feeding or conveying sheets, it is possible to judge whether the amount of water contained in sheets is large or small. The heater 8 can be energized only when the amount of water contained in sheets is large (when dehumidification is necessary). Since the heater 8 is not operated unless necessary, no energy is wasted. Also, since sheets can be kept in a dry state, occurrence of double feeding and jams can be reduced. Reduced occurrence of double feeding or jams makes it possible to provide a sheet feeding device requiring less effort and time to recover from an error.

A plurality of first terminals are provided. When the judging resistance value is determined, the controller 1 sequentially switches the first terminal to which the detection voltage E is applied. The controller 1 finds the resistance value of a bundle of sheets for each first terminal. The controller 1 determines as the judging resistance value the average value of the resistance values of the bundle of sheets that are found a plurality of times. After a plurality of resistance values of the bundle of sheets are found, their average values can be determined as the judging resistance value. Adopting the average value allows accurate determination of a judging resistance value.

The first terminal is either or both of the sheet feeding roller 61 which makes contact with the topmost sheet to feed out the sheet and the metal claw which makes contact with the topmost sheet to press the sheet. A member involved in sheet feeding can be used as the first terminal. It is not necessary to provide a member dedicated to applying a voltage to the topmost sheet. A plurality of functions (operation) can be given to the first terminal. The manufacturing cost can thus be reduced.

The second terminal is the lift plate 71 on which a bundle of sheets are placed and which brings the topmost sheet and the sheet feeding roller 61 into contact with each other. The lift plate 71 is a metal plate. The lift plate 71 on which sheets are set can be used as the second terminal. It is not necessary to provide a special member as the second terminal.

The printer 100 includes the remaining sheet quantity sensor 65. The controller 1, based on the output of the remaining sheet quantity sensor 65, recognizes the remaining level of sheets set in the sheet cassette 7. The larger the remaining quantity is, the larger threshold value the controller 1 selects. The smaller the remaining quantity is, the smaller threshold value the controller 1 selects. In accordance with the remaining quantity of sheets (the thickness of a bundle of sheets), the threshold value can be changed. In accordance with the remaining quantity of sheets, it is possible to accurately judge whether the amount of water contained in sheets is large (whether or not to dehumidify with the heater 8).

The controller 1 judges the necessity for dehumidification every prescribed measurement period T1. It is possible to periodically judge whether dehumidification by the heater 8 is necessary. Before the amount of water contained in the sheet becomes too large, it is possible to start dehumidification by the heater 8. It is possible to maintain the bundle of sheets that are set in the sheet cassette 7 in a dry state.

The detection resistor R2 may be provided of which one end is connected to the second terminal and the other end is connected to ground. The terminal-to-terminal voltage of the detection resistor R2 is fed to the controller 1 as the resistance value judging voltage value V1. Based on the magnitude of the resistance value judging voltage value V1, the controller 1 may find the resistance value of a bundle of sheets. It is possible to recognize the magnitude of the current I passing through a bundle of sheets with a simple structure.

The storage medium 2 stores resistance value definition data D1 in a non-volatile manner. Resistance value definition data D1 is data in which the resistance value of the bundle of sheets corresponding to the resistance value judging voltage value V1 is defined. The controller 1 refers to resistance value definition data D1 to find the resistance value of the bundle of sheets. The resistance value of the bundle of sheets can be found quickly.

When a time point at which the necessity for dehumidification is periodically judged comes in power saving mode, the power supply 9 temporarily restarts the supply of electric power to the controller 1, and when the judgement is completed, stops the supply of electric power to the controller 1. Even when power saving mode lasts long, it is possible to maintain the bundle of sheets in a dried state.

The embodiment mentioned above deals with a case where the main power to the printer 100 is on. The power supply 9 may operate the heater 8 all the time when the main power to the printer 100 is off. In other words, when the main power of the printer 100 is off, the power supply 9 may energize the heater 8 all the time. In this way, even when the printer is not used for a long time, sheets do not become excessively damp.

The description given above of embodiments of the present disclosure is in no way meant to limit the scope of the present disclosure; the present disclosure can be implemented with any modifications made without departing from the spirit of the present disclosure.

What is claimed is:

1. A sheet feeding device, comprising:
a sheet cassette in which sheets are set;
a heater which warms up a bundle of sheets set in the sheet cassette to dehumidify the bundle of sheets;
a first terminal which makes contact with a topmost sheet in the bundle of sheets;
a second terminal which makes contact with a bottommost sheet in the bundle of sheets; and
a controller which
determines a judging resistance value based on a magnitude of a current passing through the bundle of sheets in the sheet cassette with a detection voltage applied to the first terminal when judging necessity for dehumidification,
operates the heater when the determined judging resistance value is equal to or lower than a prescribed threshold value, and
does not operate the heater when the determined judging resistance value is higher than the prescribed threshold value.

2. The sheet feeding device according to claim 1,
wherein
a plurality of the first terminals are provided, and
the controller, when determining the judging resistance value,
sequentially switches the first terminal to which the detection voltage is applied,
finds a resistance value of the bundle of sheets for each of the first terminals, and
determines as the judging resistance value an average value of the resistance values of the bundle of sheets found a plurality of times.

3. The sheet feeding device according to claim 1,
wherein
the first terminal is either or both of a sheet feeding roller which makes contact with the topmost sheet to feed out the sheet and a metal claw which makes contact with the topmost sheet to press the sheet.

4. The sheet feeding device according to claim 1,
wherein
the second terminal is a lift plate on which the bundle of sheets are placed and which brings the topmost sheet and the sheet feeding roller into contact with each other, and
the lift plate is a metal plate.

5. The sheet feeding device according to claim 1, further comprising a remaining sheet quantity sensor,
wherein
the controller
recognizes a remaining level of sheets set in the sheet cassette based on an output value of the remaining sheet quantity sensor,
increases the threshold value as a remaining quantity becomes larger, and
decreases the threshold value as the remaining quantity becomes smaller.

6. The sheet feeding device according to claim 1,
wherein
the controller judges the necessity for dehumidification every prescribed measurement period.

7. The sheet feeding device according to claim 1, further comprising a detection resistor of which one end is connected to the second terminal and of which another end is connected to ground,
wherein
a terminal-to-terminal voltage of the detection resistor is fed to the controller as a resistance value judging voltage value, and
based on the magnitude of the resistance value judging voltage value, the controller finds the resistance value of the bundle of sheets.

8. The sheet feeding device according to claim 7, further comprising a storage medium which stores resistance value definition data in a non-volatile manner,
wherein
the resistance value definition data is data in which the resistance value of the bundle of sheets corresponding to the resistance value judging voltage value is defined, and
the controller refers to the resistance value definition data to find the resistance value of the bundle of sheets.

9. The sheet feeding device according to claim 1, further comprising a power supply which temporarily restarts supply of electric power to the controller when a time point at which to periodically judge the necessity for dehumidification comes during power saving mode and which stops the supply of electric power to the controller when judgement is completed.

10. A method of controlling a sheet feeding device, comprising:
setting sheets in a sheet cassette,
bringing a first terminal into contact with a topmost sheet in the bundle of sheets,
bringing a second terminal into contact with a bottommost sheet in the bundle of sheets,
determining a judging resistance value based on a magnitude of a current passing through the bundle of sheets in the sheet cassette with a detection voltage applied to the first terminal when judging necessity for dehumidification,
operating a heater which warms up the bundle of sheets set in the sheet cassette to dehumidify the bundle of sheets when the determined judging resistance value is equal to or lower than a prescribed threshold value, and
not operating the heater when the determined judging resistance value is higher than the prescribed threshold value.
